(19) United States
(12) Patent Application Publication
(10) Pub. No.: US 2023/0025236 A1
(43) Pub. Date: Jan. 26, 2023

(54) LIDAR SYSTEM DETECTING WINDOW BLOCKAGE

(71) Applicant: Continental Automotive Systems, Inc., Auburn Hills, MI (US)

(72) Inventor: Nehemia Terefe, Santa Barbara, CA (US)

(73) Assignee: Continental Automotive Systems, Inc., Auburn Hills, MI (US)

(21) Appl. No.: 17/443,088

(22) Filed: Jul. 20, 2021

(51) Int. Cl. G01S 7/497; G01S 7/481; G01S 17/931

(52) U.S. Cl. CPC G01S 7/497; G01S 7/4816; G01S 7/4817; G01S 7/4813; G01S 17/931; G01S 7/4814; G01S 2007/4975

(57) ABSTRACT

A LiDAR system includes a casing having a window, a light emitter in the casing, a light sensor including an array of photodetectors, and a scanning mirror between the window and the light sensor. The LiDAR system includes a controller programmed to move the scanning mirror to a plurality of different positions when the light emitter is inactive. The scanning mirror is aimed at a different subset of the photodetectors in the different positions. The controller is programmed to operate at least some of the photodetectors when the scanning mirror is in different positions and the light emitter is inactive. The controller is programmed to identify a blockage on the window based on comparison of detected light at different positions of the scanning mirror.

### BACKGROUND

A solid-state LiDAR (Light Detection And Ranging) system includes an array of photodetectors that is fixed in place relative to a carrier, e.g., a vehicle. Light is emitted into the field of view of the photodetectors and the photodetectors detect light that is reflected by an object in the field of view, conceptually modeled as a packet of photons. For example, the LiDAR system emits pulses of light, e.g., laser light, into the field of view. The detection of reflected light is used to generate a three-dimensional (3D) environmental map of the surrounding environment. The time of flight of reflected photons detected by the photodetectors is used to determine the distance of the object that reflected the light.

The LiDAR system may be mounted on a vehicle to detect objects in the environment surrounding the vehicle and to detect distances of those objects for environmental mapping. The output of the LiDAR system may be used, for example, to autonomously or semi-autonomously control operation of the vehicle, e.g., propulsion, braking, steering, etc. Specifically, the system may be a component of or in communication with an advanced driver-assistance system (ADAS) of the vehicle. The LiDAR system includes a casing mounted to the vehicle and at least one window for outputting and receiving light. Blockages on the window interfere with output and receipt of light. Blockages can include, for example, water drops, snow, salt, ice, condensation, splash, spray, dirt, mud, dust, fouling, stickers, damage to the window (e.g., crack, scratch, chip), etc. A blockage can block light output to reduce the maximum detectable distance, degrade the quality of the environmental map created with the returns, interfere with the field of view, and/or generate a halo and/or false returns.

### BRIEF DESCRIPTION OF THE DRAWINGS

FIG. 1 is a perspective view of a vehicle including a LiDAR assembly.

FIG. 2 is a perspective view of the LiDAR assembly.

FIG. 3 is a schematic view of a portion of the LiDAR assembly in an active mode with a light emitter emitting light external to the LiDAR assembly and a scanning mirror directly light returned to the LiDAR assembly to a light sensor.

FIG. 4 is a schematic view of a portion of the LiDAR assembly in a passive mode with the light emitter inactive and the scanning mirror directly light to the light sensor.

FIG. 5 is the schematic view of FIG. 4 with a blockage on the window.

FIG. 6 is the schematic view of FIG. 5 with the scanning mirror in a different position to direct light from a different section of the window to a different subset of photodetectors of the light sensor.

FIG. 7 is a perspective view of the light sensor.

FIG. 7A is a schematic view of a portion of an array of photodetectors of the light sensor.

FIG. 8 is a block diagram of a portion of the vehicle and the LiDAR system.

FIG. 9 is a flow chart showing an example operation of the LiDAR system.

### DETAILED DESCRIPTION

With reference to the figures in which like numerals are used to identify like parts, a LiDAR system 10 includes a casing 12 having a window 14, a light emitter 16 in the casing 12, a light sensor 18 including an array of photodetectors 22, and a scanning mirror 20 between the window 14 and the light sensor 18. The LiDAR system 10 includes a controller 24 programmed to move the scanning mirror 20 to a plurality of different positions when the light emitter 16 is inactive. The scanning mirror 20 is aimed at different positions when the light emitter 16 is inactive. The scanning mirror 20 is aimed at a different subset of the photodetectors 22 in the different positions. The controller 24 is programmed to operate at least some of the photodetectors 22 when the scanning mirror 20 is in different positions and the light emitter 16 is inactive. The controller 24 is programmed to identify a blockage on the window 14 based on comparison of detected light at different positions of the scanning mirror 20.

The scanning mirror 20 and the photodetectors 22 are used in an active mode and in a passive mode. In the active mode, the light emitter 16 emits light into a field of illumination FOI exterior to the LiDAR system 10. The photodetectors 22 can then detect light returned through the window 14 and directed to the photodetector 22 by the scanning mirror 20. Specifically, the scanning mirror 20 scans through various positions of a scene exterior to the LiDAR system 10 to direct light returned from sections of the scene to the photodetectors 22. The photodetectors 22 detect light at various position of the scanning mirror 20 and the light detection at these various sections of the scene are assembled together to generate a complete scene. The light emitter 16 is inactive in the passive mode. In other words, the light emitter 16 is not activated and does not emit light into a field of view FOV of the photodetectors 22. With the light emitter 16 inactive, the scanning mirror 20 scans through positions aimed at different sections of the window 14. With the light emitter 16 inactive, the photodetectors 22 detect light entering through the window 14, e.g., ambient light. This detection of light by the photodetectors 22 is used to identify blockages on the window 14. As one example, and as described further below, blockages may be identified by detecting differences in light reception at blocked and unblocked portions of the window 14. As another example, and as further described below, blockages may be identified by detecting scattered light. Such an example may be useful in identifying diffuse blockages on the window 14. Blockages can include, for example, water drops, snow, salt, ice, condensation, splash, spray, dirt, mud, dust, fouling, stickers, damage to the window 14 (e.g., crack, scratch, chip), etc.

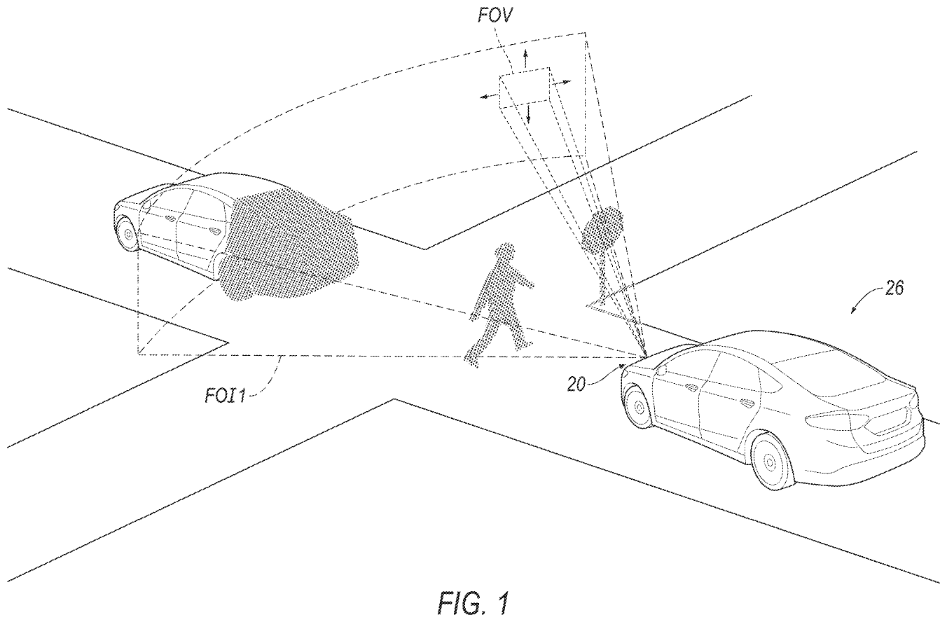

The LiDAR system 10 is shown in FIG. 1 as being mounted on a vehicle 26. In such an example, the LiDAR system 10 is operated to detect objects in the environment surrounding the vehicle 26 and to detect distance, i.e., range, of those objects for environmental mapping. The output of the LiDAR system 10 may be used, for example, to autonomously or semi-autonomously control operation of the vehicle 26, e.g., propulsion, braking, steering, etc. Specifically, the LiDAR system 10 may be a component of or in communication with an advanced driver-assistance system (ADAS 32) of the vehicle 26. The LiDAR system 10 may be mounted on the vehicle 26 in any suitable position and aimed in any suitable direction. As one example, the LiDAR system 10 is shown on the front of the vehicle 26 and directed forward. The vehicle 26 may have more than one LiDAR system 10 and/or the vehicle 26 may include other object detection systems, including other LiDAR systems. The vehicle 26 shown in the Figures is a passenger automobile. As other examples, the vehicle 26 may be of any suitable manned or un-manned type including a plane, satellite, drone, watercraft, etc.

The LiDAR system 10 may be a solid-state LiDAR. In such an example, the LiDAR system 10 is stationary relative to the vehicle 26 in contrast to a mechanical LiDAR, also called a rotating LiDAR, that rotates 360 degrees. Specifically, the casing 12 is fixed relative to the vehicle 26, i.e., does not move relative to the component of the vehicle 26 to which the casing 12 is attached, and components of the LiDAR system 10 are supported in the casing 12. Illumination by the solid-state LiDAR may be of any suitable type. For example, the LiDAR system 10 may be a flash LiDAR system 10. In such an example, the LiDAR system 10 emits pulses, i.e., flashes, of light into the field of illumination FOI. More specifically, the LiDAR system 10 may be a 3D flash LiDAR system that generates a 3D environmental map of the surrounding environment. Another example of solid-state LiDAR includes an optical-phase array (OPA). Another example of solid-state LiDAR is a micro-electromechanical system (MEMS) scanning LiDAR, which may also be referred to as a quasi-solid-state LiDAR.

The LiDAR system 10 emits light and detects the emitted light that is reflected by an object, e.g., pedestrians, street signs, vehicles, etc. Specifically, the LiDAR system 10 includes a light-emission system 28, a light-receiving system 30, and the controller 24. The controller 24 controls the light-emission system 28 and the light-receiving system 30.

The light-emission system 28 may include one or more light emitter 16 and optical components 38. The optical components 38 may be shared between the light-emission system 20 and the light-receiving system 30, as shown in the example in the figures. The optical components 38 may include a lens package, lens crystal, pump delivery optics, etc. The optical components 38, e.g., lens package, lens crystal, etc., may be between the light emitter 16 on a back end of the casing 12 and the window 14 on a front end of the casing 12. Thus, light emitted from the light emitter 16 passes through the optical components before exiting the casing 12 through the window 14. The optical components 38 may include an optical element, a collimating lens, a beam-steering device, transmission optics, etc. The optical components 38 direct the light, e.g., in the casing 12 from the light emitter 16 to the window 14, and shapes the light, etc.

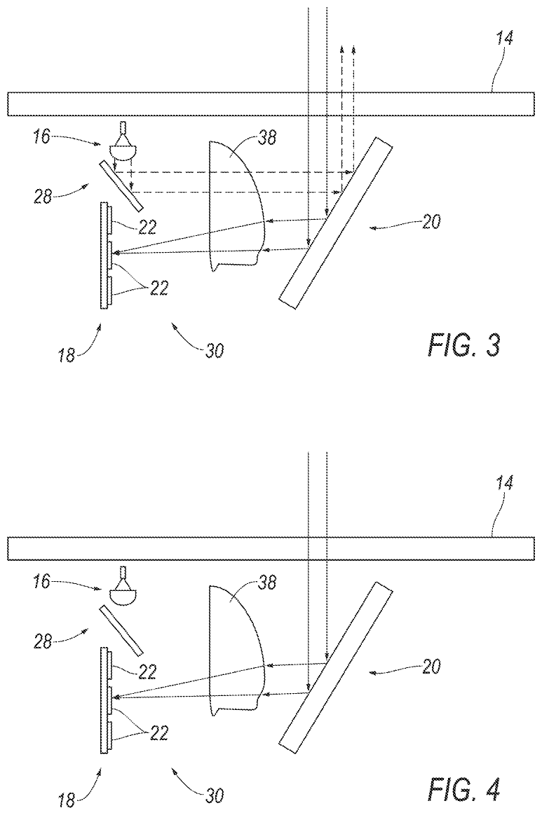

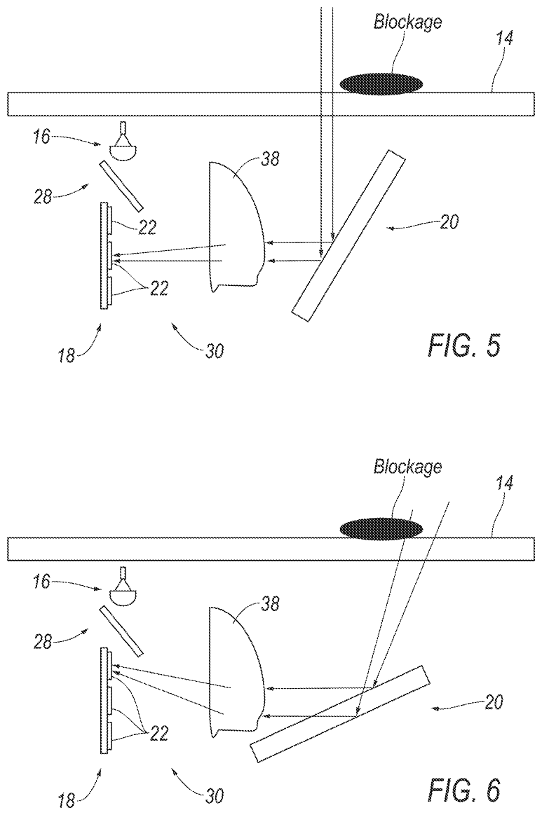

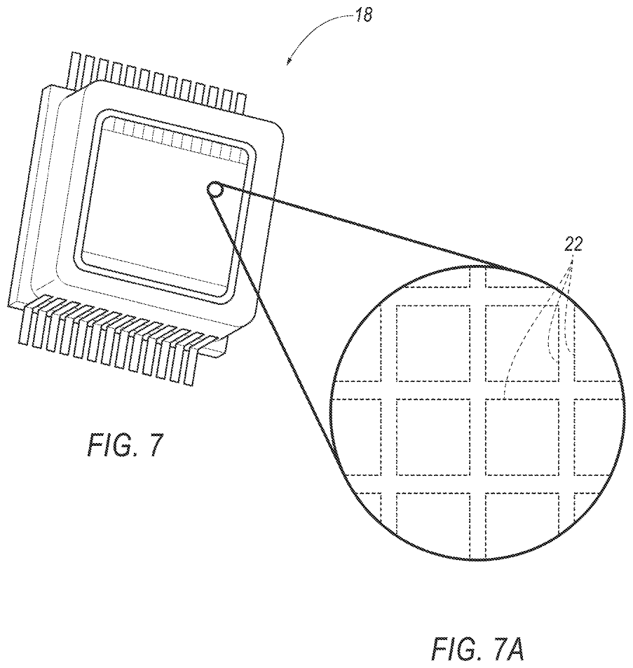

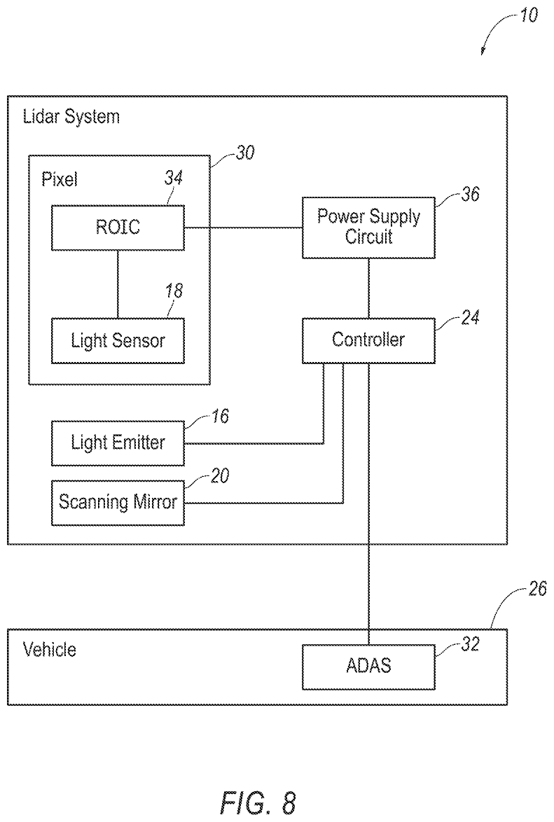

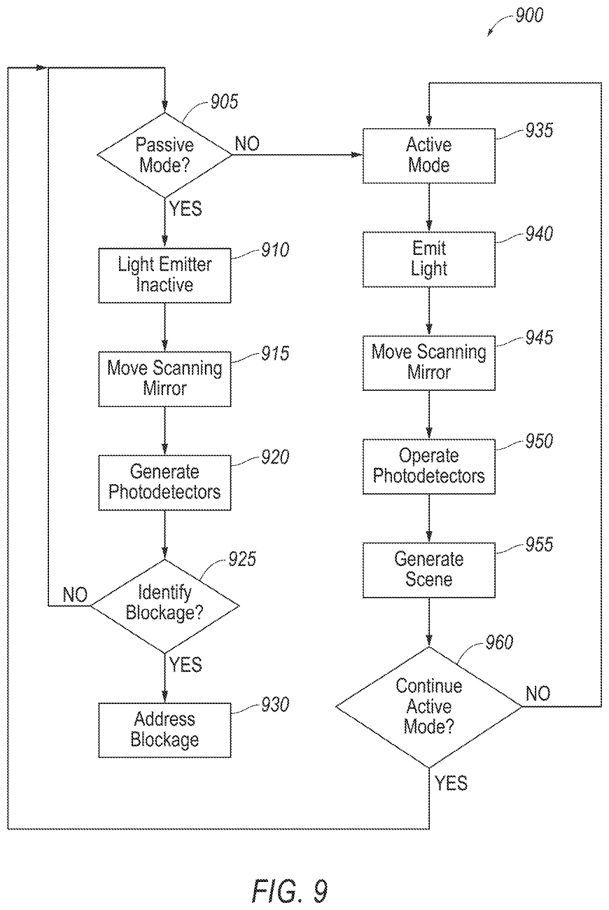

The light emitter 16 emits light through the window 14 to a field of illumination FOI exterior to the LiDAR system 10 for illuminating objects in the field of illumination FOI for detection. The optical components 38 may include transmission optics between the light emitter 16 and the window 14 and/or between the scanning mirror 20 and the window 14. The transmission optics, e.g., components such as reflectors/deflectors, diffusers, optics, etc., shape, focus, and/or direct the light from the light emitter 16 and guide the light through the exit window 14 to a field of illumination FOI. The light emitter 16 in the example shown in the figures illuminates a field of illumination FOI with a flash of light. In such an example, the field of illumination FOI is larger than the field of view transmitted from the scanning mirror 20 to the array of photodetectors 22 and the scanning mirror 20 moves the field of view FOV relative to the field of illumination FOI, as shown in FIGS. 5 and 6 as an example. As another example, the light-emission system 28 may include a beam-steering device for aiming the light from the LiDAR system 10, e.g., for moving the field of illumination FOI. The controller 24 is in communication with the light emitter 16 for controlling the emission of light from the light emitter 16 including the timing of light emission. In examples including a beam-steering device, the controller 24 also controls the beam-steering device. As an example, the LiDAR system 10 may use the scanning mirror 20 to aim the light exterior to the LiDAR system 10 in addition to aiming the field of view transmitted from the scanning mirror 20 to the array of photodetectors 22, as shown in FIG. 3. In such an example, the field of illumination FOI and the field of view move together.

The light emitter 16 may be configured to emit shots, i.e., pulses, of light into the field of illumination FOI for detection by a light-receiving system 30 when the light is reflected by an object in the field of view FOV to return photons to the light-receiving system 30. The light-receiving system 30 has a field of view (hereinafter “FOV”) that overlaps the field of illumination FOI and receives light reflected by surfaces of objects, buildings, road, etc., in the FOV. The light emitter 16 may be in electrical communication with the controller 24, e.g., to provide the shots in response to commands from the controller 24.

The light emitter 16 emits light into the field of illumination FOI for detection by the light-receiving system 30 when the light is reflected by an object in the field of view FOV. The light emitter 16 may be, for example, a laser. The light emitter 16 may be, for example, a semiconductor light emitter 16, e.g., laser diodes. In one example, the light emitter 16 is a vertical-cavity surface-emitting laser (VCSEL). As another example, the light emitter 16 may be a diode-pumped solid-state laser (DPSSL). As another example, the light emitter 16 may be an edge emitting laser diode. The light emitter 16 may be designed to emit a pulsed flash of light, e.g., a pulsed laser light. Specifically, the light emitter 16, e.g., the VCSEL or DPSSL or edge emitter, is designed to emit a pulsed laser light or train of laser light pulses. The light emitted by the light emitter 16 may be, for example, infrared light. Alternatively, the light emitted by the light emitter 16 may be of any suitable wavelength. The LiDAR system 10 may include any suitable number of light emitters, i.e., one or more in the casing 12. In examples that include more than one light emitter 16, the light emitters may be identical or different.

The light-receiving system 30 has a field of view FOV that overlaps the field of illumination FOI and receives light reflected by objects in the FOV. As described further below, the scanning mirror 20 moves the field of view relative to the field of illumination to scan the field of illumination and direct light from sections of the field of illumination to the light sensor 18. The light-receiving system 30 includes the light sensor 18 and may include receiving optics, which may be or include the optical components 38 described above. The receiving optics may be of any suitable type and size. As set forth above, the light-receiving system 30 includes the light sensor 18 including the array of photodetectors 22, i.e., a photodetector 22 array. The light sensor 18 includes a chip and the array of photodetectors 22 is on the chip. The chip may be silicon (Si), indium gallium arsenide (InGaAs), germanium (Ge), etc., as is known. The chip and the photodetectors 22 are shown schematically. The array of photodetectors 22 is 2-dimensional. Specifically, the array of photodetectors 22 includes a plurality of photodetectors 22 arranged in columns and rows.

Each photodetector 22 is light sensitive. Specifically, each photodetector 22 detects photons by photo-excitation of electric carriers. An output signal from the photodetector 22 indicates detection of light and may be proportional to the amount of detected light. The output signals of each photodetector 22 are collected to generate a scene detected by the photodetector 22. The photodetectors 22 may be of any suitable type, e.g., photodiodes (i.e., a semiconductor device having a p-n junction or a p-i-n junction) including avalanche photodiodes (which may be operated linearly or as a single-photon avalanche diode (SPAD)), metal-semiconductor-metal photodetectors 22, phototransistors, photoconductive detectors, phototubes, photomultipliers, etc. As an example, the photodetectors 22 may each be a silicon photomultiplier (SiPM). As another example, the photodetectors 22 may each be or a PIN diode. The photodetectors 22 may be sensitive to light in any suitable wavelength. For example, the photodetectors 22 may be sensitive to visible light, infrared light, and/or any other suitable wavelength.

Each photodetector 22 may be a component of a pixel. The LiDAR system 10 includes multiple pixels, and each pixel can include one or more photodetectors 22 each configured to detect incident light. For example, a pixel can output a count of incident photons, a time between incident photons, a time of incident photons (e.g., relative to an illumination output time), or other relevant data, and the system can transform these data into distances from the LiDAR system 10 to external surfaces in the fields of view FOV of these pixels. By merging these distances with the position of pixels at which these data originated and relative positions of these pixels at a time that these data were collected, the LiDAR system 10 (or other device accessing these data) can reconstruct a three-dimensional (virtual or mathematical) model of a space occupied by the LiDAR system 10, such as in the form of 3D image represented by a rectangular matrix of range values, wherein each range value in the matrix corresponds to a polar coordinate in 3D space. The pixel functions to output a single signal or stream of signals corresponding to a count of photons incident on the pixel within one or more sampling periods. Each sampling period may be picoseconds, nanoseconds, microseconds, or milliseconds in duration. The pixel can output a count of incident photons, a time between incident photons, a time of incident photons (e.g., relative to an illumination output time), or other relevant data, and the LiDAR system 10 can transform these data into distances from the system to external surfaces in the fields of view of these pixels. By merging these distances with the position of pixels at which these data originated and relative positions of these pixels at a time that these data were collected, the controller 24 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space. The pixels may be arranged as an array, e.g., a 2-dimensional (2D) or a 1-dimensional (1D) arrangement of components. A 2D array of pixels includes a plurality of pixels arranged in columns and rows. Each pixel may include a power-supply circuit 36 or may share one or more power-supply circuits 36 of the LiDAR system 10. Each pixel may include a read-out integrated circuit (ROIC) or multiple pixels may share a ROIC 34.

The light receiving system includes the ROIC 34 for converting an electrical signal received from photodetectors 22 of the array of photodetectors 22 to digital signals. The ROIC 34 may include electrical components which can convert electrical voltage to digital data. The ROIC 34 may be connected to the controller 24, which receives the data from the ROIC 34 and may generate 3D environmental map based on the data received from the ROIC 34.

The light-receiving system 30 may include passive electrical components such as capacitors, resistors, etc. The light-receiving system 30 and the light-emission system 28 may be optically separated from one another by an optical barrier. An optical barrier may be formed of plastic, glass, and/or any other suitable material that blocks passage of light. In other words, an optical barrier prevents detection of light emitted from the light-emission system 28, thus limiting the light received by the light-receiving system 30 to light received from the FOV of the LiDAR system 10.

Data output from the ROIC 34 may be stored in a memory chip for processing by the controller 24. The memory chip may be a DRAM (Dynamic Random Access Memory), an SRAM (Static Random Access Memory), and/or a MRAM (Magneto-resistive Random Access Memory) may be electrically connected to the ROIC 34. In one example, an light-receiving system 30 may include the memory chip electrically connected to the ROIC 34. Additionally or alternatively, the memory chip can be a separate chip.

The LiDAR system 10 may be a unit. Specifically, the casing 12 supports the light-emission system 28 and the light-receiving system 30. The casing 12 may enclose the light-emission system 28 and the light-receiving system 30. The casing 12 may include mechanical attachment features to attach the casing 12 to the vehicle 26 and electronic connections to connect to and communicate with electronic system of the vehicle 26, e.g., components of the ADAS 32. The casing 12, for example, may be plastic or metal and may protect the other components of the LiDAR system 10 from moisture, environmental precipitation, dust, etc. In the alternative to the LiDAR system 10 being a unit, components of the LiDAR system 10, e.g., the light-emission system 28 and the light-receiving system 30, may be separated and disposed at different locations of the vehicle 26.

The window 14 extends through the casing 12 and may include a lens or other optical device at the casing 12. The window 14 may include one or more segments. In the example shown in the figures, the LiDAR system 10 includes one segment through which light from the light emitter 16 is emitted and light returned from the field of illumination FOI to the light sensor 18 is transmitted through the one segment of the LiDAR system 10. As another example, the window 14 may include one segment for the light emitter 16 and one segment for the light sensor 18. In examples in which the window 14 includes more than one segment, the segments may be separated by portions of the casing 12, e.g., plastic, metal, etc.

The window 14 allows light to pass through, e.g., light generated by the light-emitting system exits the LiDAR system 10 and/or light from environment enters the LiDAR system 10. The window 14 protects an interior of the LiDAR system 10 from environmental conditions such as dust, dirt, water, etc. The window 14 is a transparent or semi-transparent material, e.g., glass, plastic, with respect to the wavelength of the emitted light. The window 14 may be opaque at other wavelengths, which may assist in the overall reduction of ambient light, e.g., may include a bandpass filter. The window 14 may extend from the casing 12 and/or may be attached to the casing 12.

As set forth above, the scanning mirror 20 is operated in an active mode and in a passive mode of the LiDAR system 10. The light emitter 16 is active, i.e., emits light into the field of view FOV, during the active mode and is inactive, i.e., does not emit light into the field of view exterior to the LiDAR system 10 that can be detected by the scanning mirror 20 or the light sensor 18, during the passive mode.

The scanning mirror 20 is between the window 14 and the light sensor 18. The scanning mirror 20 is moveable to different positions to aim at different subsets of the photodetectors 22 at the different positions. The scanning mirror 20 illuminates the subset of the photodetectors 22 at which the scanning mirror 20 is aimed. In other words, the scanning mirror 20 directs light from the window 14 to the subset of photodetectors 22, as described further below. The subset of photodetectors 22 is a group of one or more of the photodetectors 22. In an example in which the subset is a group of photodetectors 22, the photodetectors 22 may be adjacent one another.

The scanning mirror 20 illuminates the photodetectors 22 with light emitted by the light emitter 16 through the window 14 and reflected by an object in a field of illumination of the light emitter 16, i.e., when the light emitter 16 is active. The photodetectors 22 are not illuminated by the light emitter 16 when the photodetectors 22 are operated and the light emitter 16 is inactive. The scanning mirror 20 illuminates the photodetectors 22 at which the scanning mirror 20 is aimed both when the light emitter 16 is active and inactive. Specifically, when the light emitter 16 is active, the scanning mirror 20 directs light to the light sensor 18 that emitted by the light-emission system 28 into the field of illumination and reflected from an object in the field of illumination FOI to the scanning mirror 20. When the light emitter 16 is inactive, the scanning mirror 20 directs ambient light (such as sunlight, vehicle headlamps, streetlights, etc.) from the exterior of the casing 12 to the light sensor 18, i.e., light not generated by the light emitter 16.

As one example, the scanning mirror 20 includes an active mirror, i.e., a movable mirror, that is adjustable to aim field of view of the light sensor 18. Specifically, the scanning mirror 20 directs light coming into the casing 12 through the window 14 to the light sensor 18. The scanning mirror 20 moves relative to window 14 to direct light from different sections of the field of illumination to the light sensor 18. The field of view transmitted by the scanning mirror 20 to the light sensor 18 is smaller than the field of illumination emitted by the light-emission system 28 through the window 14 and exterior to the casing 12. Accordingly, the scanning mirror 20 moves the field of view FOV to various positions across the field of illumination FOI. The light sensor 18 detects light returned to the scanning mirror 20 from these positions in the field of illumination FOI. The photodetectors 22 detect light at various positions of the scanning mirror 20 and these various sections of the scene in the field of illumination FOI are assembled together to generate a complete scene.

The scanning mirror 20 may include an micromirror array. For example, the scanning mirror 20 may be a micro-electro-mechanical system (MEMS) mirror array. As an example, the scanning mirror 20 may be a digital micromirror device (DMD) that includes an array of pixel-mirrors that are capable of being tilted to deflect light. As another example, the scanning mirror 20 may include a mirror on a gimbal that is tilted, e.g., by application of voltage. As another example, the scanning mirror 20 may be a liquid-crystal solid-state device including an array of pixels. In such examples, the scanning mirror 20 is designed to move the field of view FOV to discrete positions by adjusting the micromirror array or the array of pixels. As another example, the scanning mirror 20 may be a spatial light modulator or metamaterial with an array of pixels or continuous medium or may be a mirror placed within a set of voice coil technology used to steer the mirror.

The scanning mirror 20 may be designed to move the field of view FOV to discrete positions and light is detected by the light sensor 18 at each discrete position. The discrete positions are “discrete” in that the positions are individually distinct from each other. The discrete positions may overlap adjacent discrete positions. The discrete positions may be stopped positions or may be temporal, i.e., positions at different times. Said differently, as one example, the scanning mirror 20 may stop the scan at each discrete position and light is detected by the light sensor 18 at each discrete position. As another example, the scanning mirror 20 may continuously scan (i.e., without stopping) and each discrete position is a different position of the scan at different times.

The scanning mirror 20 scans through a sequence of the discrete positions. For example, the position sequence may be a sequence of stopped positions or a sequence of times during a continuous scan, as described above. Each discrete position in the sequence may be adjacent or overlapping the previous discrete position and the following discrete position in the sequence. The light emitter 16 may emit a flash of light at each discrete position, i.e., light is not be emitted while moving to between discrete positions. The discrete positions are “discrete” in that positions are individually distinct, i.e., different positions, however, the FOI of adjacent discrete positions may overlap.

The scanning mirror 20 is designed to adjust the aim of the scanning mirror 20 to move the field of view FOV relative to the array of photodetectors 22. For example, when the scanning mirror 20 is aimed in the first discrete position, the field of view FOV is aimed at a first section of the scene external to the window 14. In other words, light returned to the LiDAR system 10 from an object in the field of view FOV is received by the scanning mirror 20, which directs the light to the light sensor 18. Likewise, when the scanning mirror 20 is aimed at the second discrete position, the field of view FOV is aimed at a second segment of the scene.

Each photodetector 22 of the array of photodetectors 22 is illuminated at least once in the combination of all discrete positions of the field of view FOV. In the example shown in the figures, the scanning mirror 20 moves relative to the photodetectors 22. Specifically, less than all of the photodetectors 22 are illuminated by the scanning mirror 20 in any given position of the scanning mirror 20. As the scanning mirror 20 moves to different positions, the scanning mirror 20 directs light from different sections of the scene to different sections of the array of photodetectors 22. The output from the different sections of the array of photodetectors 22, each corresponding to a different section of the scene, are combined together to generate a complete scene.

The controller 24 is in electronic communication with the pixels (e.g., with the ROIC 34 and power-supply circuit 36) and the vehicle 26 (e.g., with the ADAS 32) to receive data and transmit commands. The controller 24 may be configured to execute operations disclosed herein. Specifically, the controller 24 may include programming executable to perform the method 900 shown in FIG. 9. Examples of executable programming are described further below.

The controller 24 may be a microprocessor-based controller or field programmable gate array (FPGA), or a combination of both, implemented via circuits, chips, and/or other electronic components. In other words, the controller 24 is a physical, i.e., structural, component of the system. The controller 24 may include a processor, memory, etc. The memory of the controller 24 may store instructions executable by the processor, i.e., processor-executable instructions, and/or may store data. The controller 24 may be in communication with a communication network of the vehicle 26 to send and/or receive instructions from the vehicle 26, e.g., components of the ADAS 32. The controller 24 is programmed to perform the method 900 in the figures. For example, instructions may be stored on the memory of the controller 24 and include instructions to perform method 900. Use herein (including with reference to the method 900 in the figures) of “based on,” “in response to,” and “upon determining,” indicates a causal relationship, not merely a temporal relationship.

The controller 24 may include a processor and a memory. The memory includes one or more forms of controller-readable media, and stores instructions executable by the controller 24 for performing various operations, including as disclosed herein. Additionally or alternatively, the controller 24 may include a dedicated electronic circuit including an ASIC (Application Specific Integrated Circuit) that is manufactured for a particular operation, e.g., calculating a histogram of data received from the LiDAR system 10 and/or generating a 3D environmental map for a field of view FOV of the vehicle 26. In another example, the controller 24 may include an FPGA (Field Programmable Gate Array) which is an integrated circuit manufactured to be configurable by a customer. As an example, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. A controller 24 may be a set of controllers communicating with one another via the communication network of the vehicle 26, e.g., a controller 24 in the LiDAR system 10 and a second controller 24 in another location in the vehicle 26.

The controller 24 may operate the vehicle 26 in an autonomous, a semi autonomous mode, or a non autonomous (or manual) mode and/or may provide data to another controller of the vehicle 26, e.g., a component of the ADAS, for operating in these various modes. For purposes of this disclosure, an autonomous mode is defined as one in which each of vehicle propulsion, braking, and steering are controlled by the controller 24; in a semi autonomous mode the controller 24 controls one or two of vehicle 26 propulsion, braking, and steering; in a non autonomous mode a human operator controls each of vehicle propulsion, braking, and steering.

The controller 24 may include programming to operate one or more of vehicle brakes, propulsion (e.g., control of acceleration in the vehicle 26 by controlling one or more of an internal combustion engine, electric motor, hybrid engine, etc.), steering, climate control, interior and/or exterior lights, etc., as well as to determine whether and when the controller 24, as opposed to a human operator, is to control such operations. Additionally, the controller 24 may be programmed to determine whether and when a human operator is to control such operations.

The controller 24 may include or be communicatively coupled to, e.g., via a vehicle 26 communication bus, more than one processor, e.g., controllers or the like included in the vehicle 26 for monitoring and/or controlling various vehicle 26 controllers, e.g., a powertrain controller, a brake controller, a steering controller, etc. The controller 24 is generally arranged for communications on a vehicle 26 communication network that can include a bus in the vehicle 26 such as a controller area network (CAN) or the like, and/or other wired and/or wireless mechanisms.

With reference to FIG. 9, the controller 24 is programmed to operate the LiDAR system 10 in both the active mode and the passive mode, as shown in decision block 905. In the active mode, the controller 24 operates the light emitter 16, the scanning mirror 20, and the light sensor 18 to illuminate a field of illumination FOI exterior to the LiDAR system 10 and detect light returned to the LiDAR system 10 by objects in the field of illumination FOI. In the passive mode, the light emitter 16 is inactive and the controller 24 operates the scanning mirror 20 and the light sensor 18 to detect blockages on the exterior of the window 14. In the event a blockage is detected, the controller 24 may provide instruction to clean the window 14, e.g., a window washing device near the window 14, to heat the window 14 to remove water on the window 14, to service the LiDAR system 10, e.g., for replacement of the window 14 or entire LiDAR system 10, etc.

With continued reference to block 905, the controller 24 operates the LiDAR system 10 in either passive mode or active mode. The decision to operate in passive mode or active mode may be made by the LiDAR system 10 or may be received by the LiDAR system 10 from the vehicle 26, e.g., the ADAS 32 of the vehicle 26. In block 905, as an example, the controller 24 decides whether the LiDAR system 10 will operate in passive mode. If in passive mode, the method 900 continues to block 905 and if in active mode the method 900 continues to block 935. As another example, the decision in block 905 could decide whether the LiDAR system 10 will operate in active mode or make a decision between both passive mode and active mode together in block 905; the organization of block 905 and 935 in FIG. 9 is by way of non-limiting example.

If operating on passive mode, the method 900 continues with the light emitter 16 inactive, as shown in block 10. In other words, the light emitter 16 does not emit light into the field of view FOV exterior to the LiDAR system 10 that can be detected by the scanning mirror 20 or the light sensor 18. As an example, the light emitter 16 may be active only in response to receiving instruction from the controller 24 to emit light. In such an example, the light emitter 16 is inactive as a result of not receiving an instruction from the controller 24 to emit light. In other words, the controller 24 does not provide instruction to the light emitter 16 to emit light in the passive mode resulting in the light emitter 16 being inactive in the passive mode.

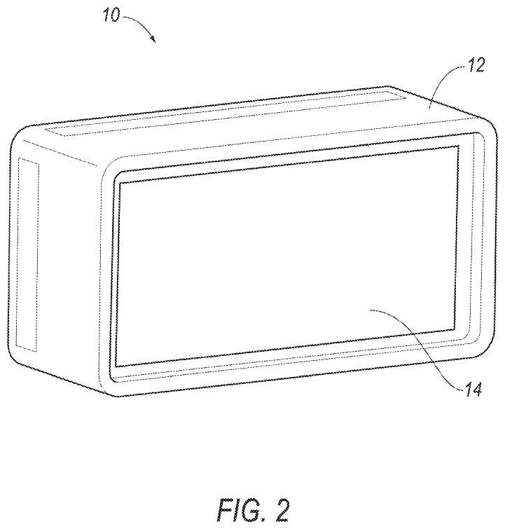

In the passive mode, the method 900 includes moving the scanning mirror 20 to a plurality of different positions when the light emitter 16 is inactive, as shown in block 915. The scanning mirror 20 is aimed at a different subset of the photodetectors 22 in the different positions, as shown in FIGS. 2-4. The scanning mirror 20 may be moved to the plurality of different positions in any suitable manner. For example, as described above, in an example in which the scanning mirror 20 includes a micromirror array, e.g., a MEMS, the micromirrors may be moved as described above.

With reference to block 920, the method 900 includes operating at least some of the photodetectors 22 when the scanning mirror 20 is in different positions and the light emitter 16 is inactive. By operating photodetectors 22 when the scanning mirror 20 is in different positions, the scanning mirror 20 returns light from various sections of the window 14. In other words, the scanning mirror 20 scans the window 14. Since the light emitter 16 is inactive in these different positions, the light returned is the light at the window 14. Accordingly, this detected light can be used to identify blockages on the window 14 as described further below.

The photodetectors 22 are operated in block 920 to detect light, as described above. When the scanning mirror 20 is in the different positions, the subset of photodetectors 22 at which the scanning mirror 20 is aimed may be operated and/or photodetectors 22 outside of that subset of photodetectors 22 may be illuminated.

With continued reference to block 920, the LiDAR system 10 may operate at least one photodetector 22 in the subset of the photodetectors 22 at which the scanning mirror 20 20 is aimed when the light emitter 16 is inactive. For example, the light detected by the photodetectors 22 in the subset of photodetectors 22 at which the scanning mirror 20 is aimed may be used to detect a blockage at the corresponding portion of the window 14 at which the scanning mirror 20 is aimed. Specifically, as the scanning mirror 20 directs light from a section of the window 14 to the subset of photodetectors 22, a blockage on the section of the window 14 will prevent or reduce light at the window 14 and this light reduction is detected by the subset of photodetectors 22 at which the scanning mirror 20 is aimed. The light detected by the photodetectors 22 in the subset at which the scanning mirror 20 is aimed may be used to detect a discrete blockage on the window 14. The discrete blockage may have relatively sharp light gradients at the edges. Examples of discrete blockages include dirt, water droplets, a crack or chip in the window 14, etc. As set forth above, the LiDAR system 10 may operate to detect a blockage on the window 14 based on light detected by the photodetectors 22 in the subset of photodetectors 22 at which the scanning mirror 20 is aimed.

With continued reference to block 920, the LiDAR system 10 may operate at least one photodetector 22 outside of the subset of the photodetectors 22 at which the scanning mirror 20 is aimed when the light emitter 16 is inactive. Operating at least one photodetector 22 outside of the subset of photodetectors 22 detects light diffused by a blockage on the window 14, e.g., a diffuse blockage. A diffuse blockage is not concentrated or localized. In other words, the light detected by the photodetectors 22 outside the subset of photodetectors 22 at which the scanning mirror 20 is aimed may be used to detect a blockage on the window 14 that scatters incoming light at the window 14. One or more diffuse blockages that scatters light at the window 14 may include dust, condensation, frost, etc. As set forth above, the LiDAR system 10 may operate to detect a blockage on the window 14 based on light detected by the photodetectors 22 outside the subset of photodetectors 22 at which the scanning mirror 20 is aimed. As another example, the LiDAR system 10 may operate to detect blockages on the window 14 based both on light detected by the photodetectors 22 in the subset of photodetectors 22 at which the scanning mirror 20 is aimed and light detected by the photodetectors 22 outside the subset of photodetectors 22 at which the scanning mirror 20 is aimed.

The LiDAR system 10 may identify the type of blockage based on the light detected by the photodetectors 22. Specifically, the type of blockage may be identified based on the position of the scanning mirror 20 and the location of the detected light. Light detected by the subset of photodetectors 22 at which the scanning mirror 20 is aimed may detect discrete blockages with that have relatively sharp light gradients at the edges, e.g., dirt, water droplet, crack in the window 14, etc. Light detected by the subset of photodetectors 22 outside of the photodetectors 22 at which the scanning mirror 20 is aimed may detect diffuse blockages that scatter light into the casing 12, e.g., dust, condensation, frost, etc.

With reference to decision block 925, the LiDAR system 10 identifies whether a blockage is on the window 14 or not. The LiDAR system 10 may identify a blockage on the window 14 based on comparison of detected light at different positions of the scanning mirror 20 when the light emitter 16 is inactive. For example, the LiDAR system 10 may compare adjacent photodetectors 22 and/or adjacent ones of the subsets of photodetectors 22 to identify the blockage. The LiDAR system 10 may identify a blockage on the window 14 based on comparison of detected light at different positions of the scanning mirror 20. Specifically, the LiDAR system 10 may identify the blockage by at least one of detecting blur, intensity gradient, or an edge of the blockage. Such methods may be used, for example, to detect discrete blockages. As set forth above, in addition to or in the alternative, the detection of light outside of the subset of photodetectors 22 illuminated by the scanning mirror 20 may be used to identify diffuse blockages. In such an example, the LiDAR system 10 uses photodetectors 22 not illuminated by the scanning mirror 20, i.e., photodetectors 22 at which the scanning mirror 20 is not aimed, to detect scattered light and compare it to the photodetectors 22 that are illuminated by the scanning mirror 20.

With reference to block 930, in the event that a blockage is detected on the window 14, the LiDAR system 10 may take action or store the information for later use. As an example, the controller 24 may provide instruction to clean the window 14, e.g., a window 14 washing device near the window 14, to heat the window 14 to remove water on the window 14, to service the LiDAR system 10, e.g., for replacement of the window 14 or entire LiDAR system 10, etc. With reference again to block 925, in the event a blockage is not on the window 14, the LiDAR system 10 continues to another process, e.g., restarting method 900 (as shown in FIG. 9), starting a different process, etc.

With reference to block 935, in active mode, the controller 24 operates the light emitter 16, scanning mirror 20, and light sensor 18 as is known to detect the scene exterior to the LiDAR system 10. Specifically, with reference to block 940, the light emitter 16 emit light from the light emitter 16 to field of illumination exterior to the window 14. As an example, light emitter 16 may emit light to the scanning mirror 20, which directs the light to the field of illumination exterior to the window 14, as shown in the example in the figures, e.g., FIG. 3.

With reference to block 945, the scanning mirror 20 illuminates the photodetectors 22 with light emitted by the light sensor 18 through the window 14 and reflected by an object in a field of illumination of the light emitter 16. Specifically, the scanning mirror 20 is aimed at a subset of the photodetectors 22 and directs light from the exterior of the window 14 to the subset of photodetectors 22. The scanning mirror 20 moves to illuminate other subsets of the photodetectors 22

With reference to block 950, the controller 24 operates at least some of the photodetectors 22 when the light emitter 16 is activated. Specifically, when the scanning mirror 20 moves, the various subsets of photodetectors 22 are operated to detect light at the various positions of the scanning mirror 20. With reference to block 955, the LiDAR system 10 generate a scene exterior to the window 14, as described above. Specifically, the scanning mirror 20 illuminates the photodetectors 22 with light emitted by the light sensor 18 through the window 14 and reflected by an object in a field of illumination of the light emitter 16.

As shown in block 960, the LiDAR system 10 may continue to operate in active mode or may switch to passive mode. This decision may be based on, for example, instructions in the LiDAR system 10 and/or instructions received by the LiDAR system 10 from the vehicle 26, e.g., from the ADAS 32 of the vehicle 26.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A LiDAR system comprising:
a casing having a window;
a light emitter in the casing;
a light sensor including an array of photodetectors;
a scanning mirror between the window and the light sensor; and
a controller programmed to:
move the scanning mirror to a plurality of different positions when the light emitter is inactive, the scanning mirror being aimed at a different subset of the photodetectors in the different positions;
operate at least some of the photodetectors when the scanning mirror is in different positions and the light emitter is inactive; and
identify a blockage on the window based on comparison of detected light at different positions of the scanning mirror.

2. The LiDAR system as set forth in claim 1, wherein the scanning mirror is between the window and the light emitter.

3. The LiDAR system as set forth in claim 2, wherein the controller is programmed to activate the light emitter to emit light from the light emitter to the scanning mirror.

4. The LiDAR system as set forth in claim 3, wherein the controller is programmed to operate at least some of the photodetectors when the light emitter is activated.

5. The LiDAR system as set forth in claim 4, wherein the scanning mirror illuminates the photodetectors with light emitted by the light emitter through the window and reflected by an object in a field of illumination of the light emitter.

6. The LiDAR system as set forth in claim 1, wherein the controller is programmed to compare adjacent ones of the subsets to identify the blockage.

7. The LiDAR system as set forth in claim 1, wherein the controller is programmed to operate at least one photodetector in the subset of the photodetectors at which the scanning mirror is aimed when the light emitter is inactive.

8. The LiDAR system as set forth in claim 7, wherein the controller is programmed to operate at least one photodetector outside of the subset of the photodetectors at which the scanning mirror is aimed when the light emitter is inactive.

9. The LiDAR system as set forth in claim 1, wherein the photodetectors are not illuminated by the light emitter when the photodetectors are operated and the light emitter is inactive.

10. The LiDAR system as set forth in claim 1, wherein the scanning mirror illuminates the subset of the photodetectors at which the scanning mirror is aimed when the light emitter is inactive.

11. The LiDAR system as set forth in claim 10, wherein the controller is programmed to operate at least one photodetector outside of the subset of the photodetectors at which the scanning mirror is aimed to detect light diffused by a blockage on the window when the light emitter is inactive.

12. The LiDAR system as set forth in claim 11, wherein the controller is programmed to operate at least one photodetector in the subset of the photodetectors at which the scanning mirror is aimed when the light emitter is inactive.

13. The LiDAR system as set forth in claim 1, wherein the controller is programmed to identify the blockage by at least one of detecting blur, intensity gradient, or an edge of the blockage.

14. A controller for a LiDAR system comprising programming executable to:
move a scanning mirror to a plurality of different positions when a light emitter is inactive, the scanning mirror being aimed at a different subset of photodetectors in the different positions,
operate at least some of the photodetectors when the scanning mirror is in different positions and the light emitter is inactive; and
identify a blockage on the window based on comparison of detected light at different positions of the scanning mirror.

15. The controller as set forth in claim 14, further comprising programming executable to activate the light emitter to emit light from the light emitter to the scanning mirror.

16. The controller as set forth in claim 15, further comprising programming executable to operate at least some of the photodetectors when the light emitter is activated.

17. The controller as set forth in claim 16, further comprising programming executable to compare adjacent ones of the subsets to identify the blockage.

18. The controller as set forth in claim 17, further comprising programming executable to operate at least one photodetector in the subset of the photodetectors at which the scanning mirror is aimed when the light emitter is inactive.

19. The controller as set forth in claim 14, further comprising programming executable to operate at least one photodetector outside of the subset of the photodetectors at which the scanning mirror is aimed to detect light diffused by a blockage on the window when the light emitter is inactive.

20. The controller as set forth in claim 19, further comprising programming executable to operate at least one photodetector in the subset of the photodetectors at which the scanning mirror is aimed when the light emitter is inactive.

21. The controller as set forth in claim 14, further comprising programming executable to identify the blockage by at least one of detecting blur, intensity gradient, or an edge of the blockage.

22. A method comprising:
moving a scanning mirror to a plurality of different positions when a light emitter is inactive, the scanning mirror being aimed at a different subset of photodetectors in the different positions;
operating at least some of the photodetectors when the scanning mirror is in different positions and the light emitter is inactive; and
identifying a blockage on the window based on comparison of detected light at different positions of the scanning mirror.

23. The method as set forth in claim 22, further comprising activating the light emitter to emit light from the light emitter to the scanning mirror.

24. The method as set forth in claim 23, further comprising operating at least some of the photodetectors when the light emitter is activated.

25. The method as set forth in claim 24, further comprising comparing adjacent ones of the subsets to identify the blockage.

26. The method as set forth in claim 25, further comprising operating at least one photodetector in the subset of the photodetectors at which the scanning mirror is aimed when the light emitter is inactive.

27. The method as set forth in claim 22, further comprising operating at least one photodetector outside of the subset of the photodetectors at which the scanning mirror is aimed to detect light diffused by a blockage on the window when the light emitter is inactive.

28. The method as set forth in claim 27, further comprising operating at least one photodetector in the subset of the photodetectors at which the scanning mirror is aimed when the light emitter is inactive.

29. The method as set forth in claim 22, further comprising identifying the blockage by at least one of detecting blur, intensity gradient, or an edge of the blockage.
